(19) United States
(12) Patent Application Publication
(10) Pub. No.: US 2010/0123108 A1
(43) Pub. Date: May 20, 2010

(54) DEVICE FOR TRANSFERRING A LOAD FROM AN OBJECT TO A LOAD-BEARING ELEMENT

(76) Inventors: Woodrow W. Holley, Malden, MA (US); Andrew Paddock, Nashua, NH (US); Jerome P. Fanucci, Lexington, MA (US); Michael McAleenan, Georgetown, ME (US); Kirk E. Survilas, Peabody, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/619,274

(22) Filed: Nov. 16, 2009

Related U.S. Application Data
(60) Provisional application No. 61/114,808, filed on Nov. 14, 2008.

(51) Int. Cl. B66F 3/08

(52) U.S. Cl. 254/98

(57) ABSTRACT

A device for transmitting a load from an object to a load-bearing element is provided. The device includes an attachment mechanism for attaching to a load-bearing element, such as a vertical stanchion. A loading mechanism includes a pressure block and a mechanism interconnecting the pressure block and the attachment mechanism. The loading mechanism can apply a preload to an object and transmit a force from the object to the load-bearing element.

### CROSS-REFERENCE TO RELATED APPLICATIONS

This application claims the benefit under 35 U.S.C. §119(e) of U.S. Provisional Patent Application No. 61/114,808, filed on Nov. 14, 2008, the disclosure of which is incorporated by reference herein.

### STATEMENT REGARDING FEDERALLY SPONSORED RESEARCH OR DEVELOPMENT

This invention was made under Navy SBIR Contract No. N00167-06-C-0011. The Government may have certain rights to this invention.

### BACKGROUND OF THE INVENTION

On US Navy sea faring cargo ships, cargo is often held in place by vertical stanchions. Typically, breakable and hazardous cargo is preloaded with wooden wedges that are driven in pairs between the stanchions and the cargo. The wedges are driven in by hammer and then nailed together. The nails are driven only partially into the wooden wedges. The stanchions typically include flanges extending the vertical length of the stanchion. The protruding section of the nails are then bent around the flanges of the stanchion to secure the wedges to the stanchion. (See FIG. 32.) The wedges are discarded as they become worn out.

### SUMMARY OF THE INVENTION

The present invention relates to a device for transferring a load from an object to a load-bearing element. The object can be, for example, cargo in a ship's hold. The load-bearing element can be, for example, a vertical or longitudinally extending stanchion disposed in compression between surfaces such as a deck or floor and an overhead grating or ceiling within the hold. The device attaches to the vertical stanchion and exerts a force against the cargo.

The device includes an attachment mechanism that attaches to the load-bearing element. The device also includes a loading mechanism for applying a load against the cargo. The loading mechanism allows the device to be roughly located adjacent the cargo and then adjusted to provide a preload against the cargo. The loading mechanism allows the cargo to be held firmly in place, and any forces tending to cause movement or shifting of the cargo while the ship is in motion are transmitted through the device to the load-bearing element and from the load-bearing element to the hull of the ship.

In one embodiment, the device includes an attachment mechanism for attaching to a load-bearing element, the load-bearing element disposed in compression between surfaces. The device includes a loading mechanism for applying a preload to an object and for transmitting a force from the object to the load-bearing element. The loading mechanism includes a pressure block and a mechanism interconnecting the pressure block and the attachment mechanism. The pressure block may include opposed guides extending outwardly toward the object to receive a pressure distribution board.

In one embodiment, the attachment mechanism includes an attachment plate, and a pair of opposed, resilient tangs extending from the attachment plate and biased inwardly toward each other and spaced to fit around edges of the load-bearing element. The attachment mechanism may include at least one elastomeric frictional member on the attachment plate to extend in frictional engagement with the load-bearing element. The attachment mechanism may include a pair of opposed gripping elements, the gripping elements including a cam surface disposed to contact the load-bearing element in a gripping position and to be out of contact with the load-bearing element in a released position, the gripping elements hingedly mounted to the attachment to rotate between the gripping position and the released position.

In one embodiment, the interconnecting mechanism includes a pair of externally threaded rods arranged in parallel. A pair of nested linkage bars includes an inner bar and a sheath, the inner bar including a pair of apertures, each aperture receiving one rod of the pair of rods for translation through the aperture. Each aperture includes a partially threaded portion for engaging the threaded rod.

In another embodiment, the interconnecting mechanism includes a pair of externally threaded rods arranged in parallel. A linkage bar extends between the pair of rods, the linkage bar including a pair of apertures, each aperture receiving one rod of the pair of rods for translation through the aperture. A pair of preloading elements are provided, each preloading element rotatable into threaded engagement with one of the threaded rods.

In another embodiment, the interconnecting mechanism includes a pair of externally threaded rods, a ball formed on an end of each rod. A pair of recesses is formed in the pressure block, each ball captured within an associated recess in the pressure block, whereby the pressure block is adjustable.

In another embodiment, the interconnecting mechanism comprises a scissor mechanism including a first set of links rotatably connected to the attachment mechanism. A second set of links is rotatably connected to the pressure block and pivotably connected to the first set of links at a pivoting joint mechanism. An actuator is connected to the first and second sets of links at the pivoting joint mechanism to extend and retract the links by rotation of the pivoting joint mechanism.

In another embodiment, the interconnecting mechanism includes a ratchet and pawl mechanism disposed to provide gross movement of the pressure block and a cam mechanism disposed to provide finer movement of the pressure block.

In another embodiment, the interconnecting mechanism includes a ratchet and pawl mechanism including a ratchet plate extending along a side of the attachment plate and attached to the pressure block. A pawl is biased into engagement with teeth on the ratchet plate. A loading handle is operable to advance and retract the ratchet plate.

In another embodiment, the interconnecting mechanism includes a rack and pinion mechanism including a rack attached to the pressure block and a pinion gear attached to the attachment mechanism and engageable with the rack to advance and retract the rack.

### DESCRIPTION OF THE DRAWINGS

The invention will be more fully understood from the following detailed description taken in conjunction with the accompanying drawings in which:

FIG. 1 is an isometric view of one embodiment of a device for transmitting a load from an object to a load-bearing element, according to the present invention;

FIG. 2 is an isometric exploded view of the device of FIG. 1;

FIG. 3 is a partial isometric view of a preloading element of the device of FIG. 1;

FIG. 4 is a front view of the device of FIG. 1 showing one preloading element in an engaged position and another preloading element in a disengaged position;

FIG. 5 is a top plan view of the device of FIG. 1;

FIG. 6 is a side view of the device of FIG. 1;

FIG. 7 is an isometric view of a further embodiment of a device for transmitting a load from an object to a load-bearing element;

FIG. 7A is an isometric view showing two devices of FIG. 7 attached to a load-bearing element;

FIG. 7B is an isometric view of an attachment plate of the device of FIG. 7;

FIG. 8 is an isometric exploded front view of the device of FIG. 7;

FIG. 9 is an isometric exploded rear view of the device of FIG. 7;

FIG. 10 is an isometric view of a still further embodiment of a device for transmitting a load from an object to a load-bearing element;

FIG. 11 is a top view of the device of FIG. 10 in an extended position;

FIG. 12 is a side view of the device of FIG. 10;

FIG. 13 is a front view of the device of FIG. 10;

FIG. 14 is an isometric view of a still further embodiment of a device for transmitting a load from an object to a load-bearing element;

FIG. 15 is an isometric view of the device of FIG. 14 attached to a load-bearing element;

FIG. 16 is a top view of the device of FIG. 14;

FIG. 17 is a side view of the device of FIG. 14 retracted so that no preload is applied to an object;

FIG. 18 is a side view of the device of FIG. 14 extended to apply a preload to an object;

FIG. 19 is a partial view of the device of FIG. 14;

FIG. 20 is a partial view a cam rod of the device of FIG. 14;

FIG. 21 is a partial isometric view of the device of FIG. 14;

FIG. 22 is an isometric view of a still further embodiment of a device for transmitting a load from an object to a load-bearing element;

FIG. 23 is an exploded isometric view of the device of FIG. 22;

FIG. 24 is a top view of the device of FIG. 22;

FIG. 25 is a side view of the device of FIG. 22;

FIG. 26 is an isometric view of the device of FIG. 22 attached to a load-bearing element;

FIG. 27 is an isometric view of a still further embodiment of a device for transmitting a load from an object to a load-bearing element;

FIG. 28 is an isometric exploded view of the device of FIG. 27;

FIG. 29 is an isometric view of the device of FIG. 27;

FIG. 30 is a side view of the device of FIG. 27;

FIG. 31 is a top view of the device of FIG. 27; and

FIG. 32 is a view of prior art wooden wedges used to preload cargo adjacent a vertical stanchion.

### DETAILED DESCRIPTION OF THE INVENTION

The disclosure of U.S. Provisional Patent Application No. 61/114,808, filed on Nov. 14, 2008, is incorporated by reference herein.

The present invention relates to a device for transferring a load from an object to a load-bearing element. The object can be, for example, cargo in a ship's hold. The load-bearing element can be, for example, a vertical stanchion mounted in compression between a deck or floor and an overhead grating or ceiling within the hold. The device attaches to the vertical stanchion and exerts a force against the cargo.

The device includes an attachment mechanism that attaches to the load-bearing element. The device also includes a loading mechanism for applying a load against the cargo. The loading mechanism allows the device to be roughly located adjacent the cargo and then adjusted to provide a preload against the cargo.

The cargo can be held firmly in place, and any forces tending to cause movement or shifting of the cargo while the ship is in motion are transmitted through the device to the load-bearing element and from the load-bearing element to the hull of the ship. Such forces can include, for example, high shock loads from an underwater explosion, which can be serious in Navy ships carrying hazardous cargo, such as munitions. The device can also withstand constant vibration from, for example, a ship's engine, which can be a significant source of vibrational loading.

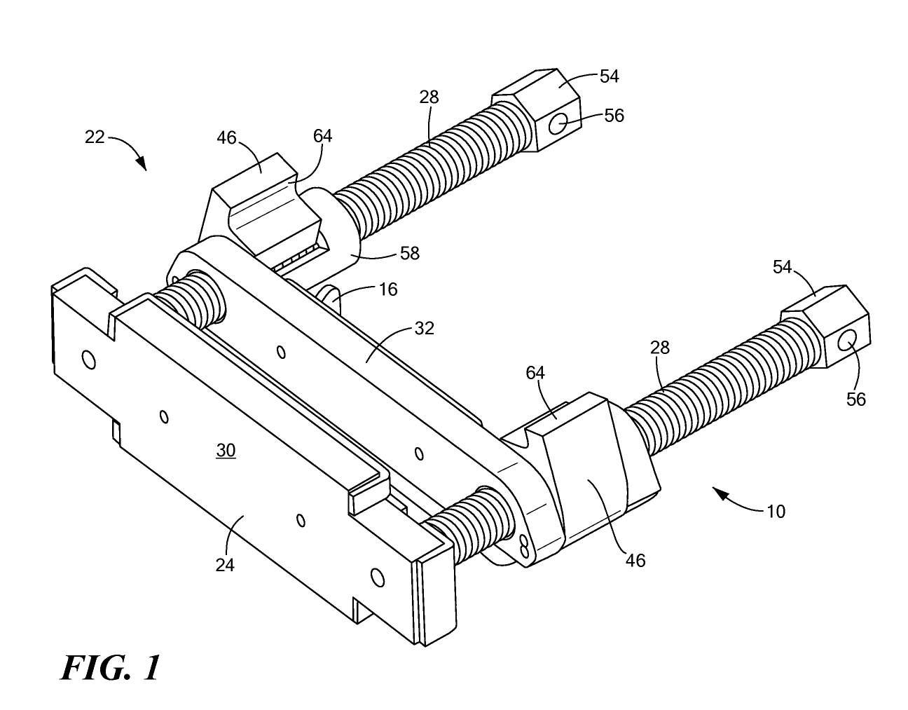

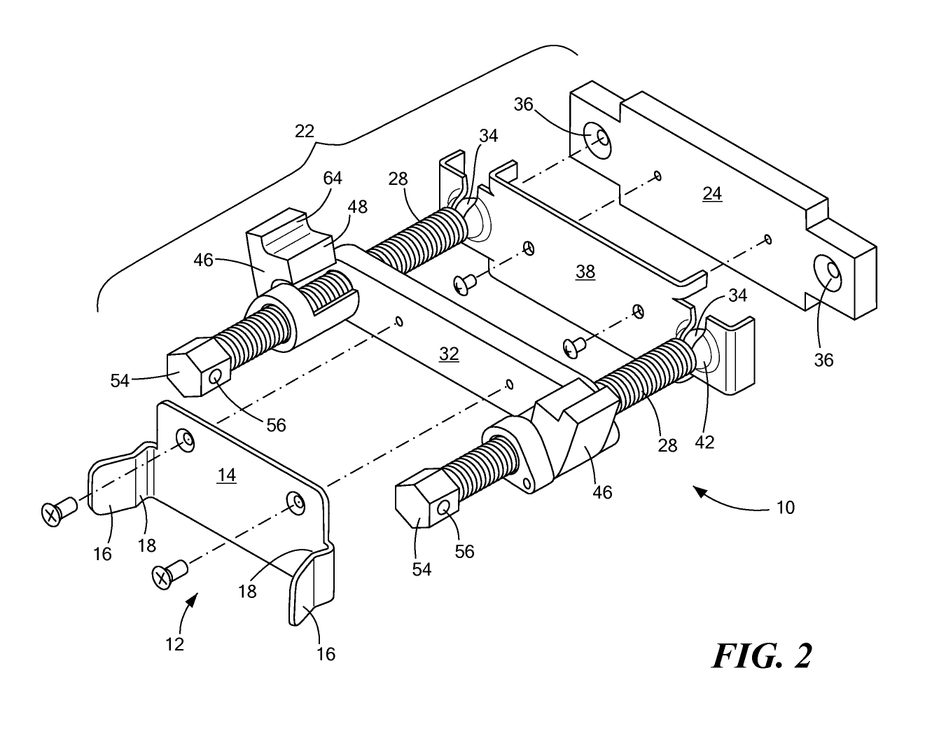

One embodiment of a device 10 for transferring a load from an object to a load-bearing element is illustrated in FIGS. 1-6. The attachment mechanism 12 includes an attachment plate 14 having a pair of resilient tangs 16 extending from one side of the plate. The tangs are biased inwardly toward each other and spaced to fit around the edges of the load-bearing element, such as a stanchion. In particular, the tangs may be shaped to fit around the flanges of the stanchion. For example, as best seen in FIG. 2, each tang is bent to provide a recess 18 to receive the flange. The attachment plate 14 with the tangs 16 is readily and simply clipped onto the stanchion at any desired location or elevation. The attachment plate can also remain in place on the stanchion, which prevents the device from becoming misplaced or lost.

The loading mechanism 22 includes a pressure block 24 affixed to front ends 26 of a pair of externally threaded rods 28 arranged in parallel. The pressure block includes a pressure surface 30 to abut against the cargo or other object. The rods are movable through apertures in a linkage bar 32 that extends between the rods. The attachment plate 14, or other attachment mechanism, is affixed to one side of the linkage bar 32, in any suitable manner such as via screws (as shown), adhesive, or the like. When the attachment plate 14 is attached to a load-bearing element, such as a stanchion, the pressure block 24 can be moved into position against the object and locked in place, described more fully as follows.

Because the object, such as cargo, is not always parallel to the load-bearing elements or may be unevenly stacked, the pressure block 24 may be self-adjustable with respect to the rods 28 to allow the block to conform to variations in the surface of the cargo against which the pressure surface abuts. In the embodiment illustrated, the front end 26 of each rod 28 includes a ball 34 that is captured within a recess or countersunk region 36 in the pressure block 24. A plate 38, having appropriate cupped portions 42 to surround each ball, is fastened to the pressure block to capture the ball within the recess or countersunk region. The plate can be fastened to the pressure block in any suitable manner, such as with screws (as shown), adhesive, or the like. In this manner, the pressure block can tilt about a horizontal axis. The pressure block can also be advanced different distances by the threaded rods to accommodate variations in the surface of the cargo.

The linkage bar 32 includes a pair of unthreaded apertures 44, each aperture receiving one rod of the pair of rods 28 for translation through the aperture. By sliding the rods through the unthreaded apertures, the pressure block can be rapidly moved into position against the object.

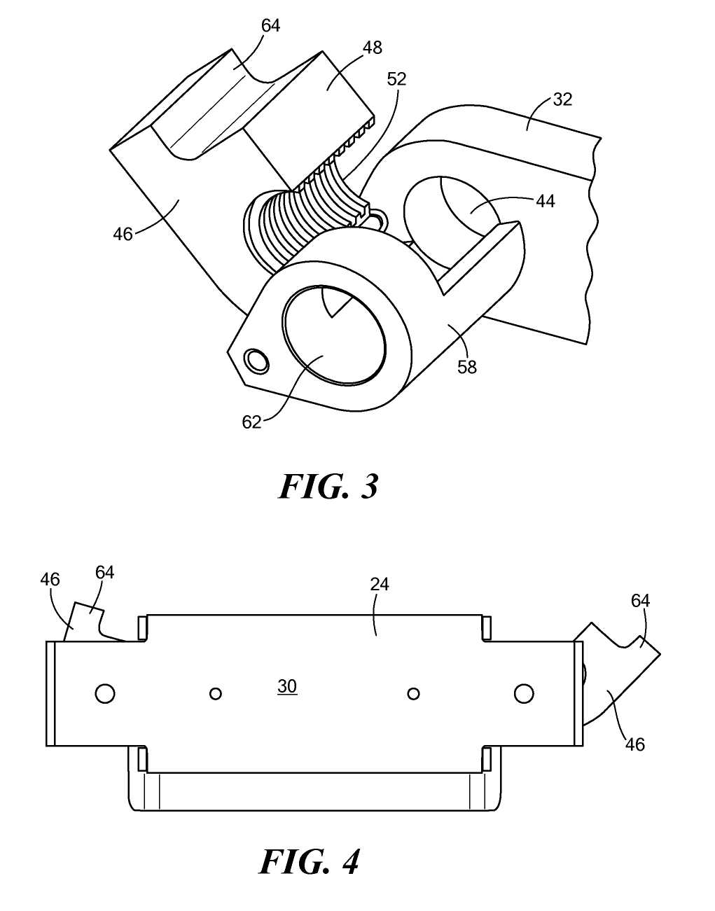

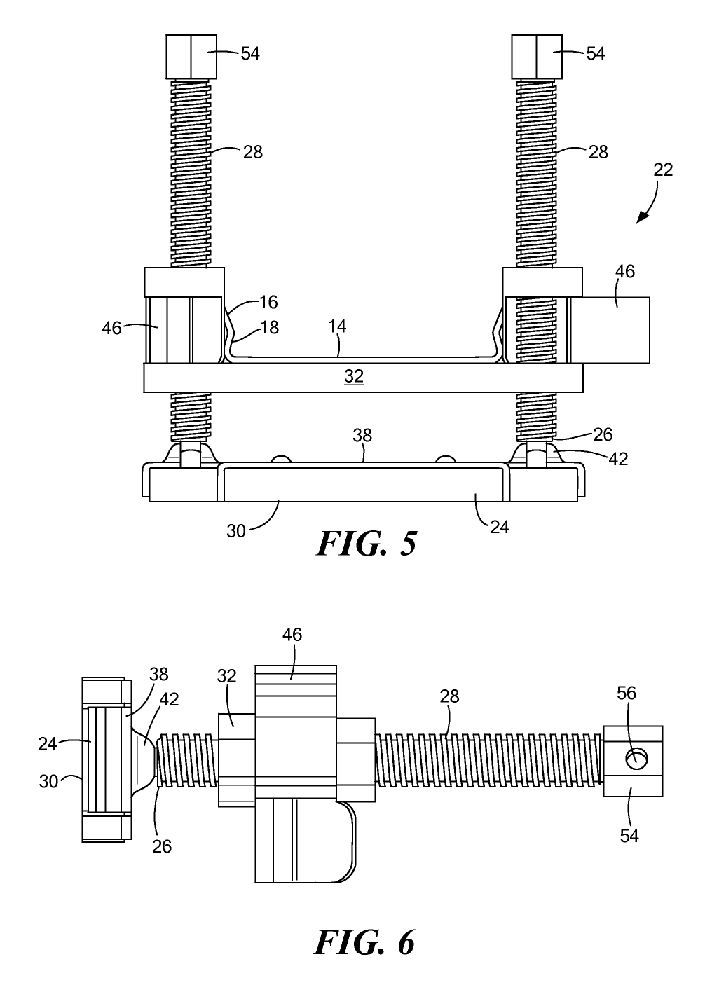

A pair of preloading elements 46 is affixed to the linkage bar. See FIG. 3. Each preloading element is associated with one of the rods 28. The preloading element includes a partial nut 48 having an inner threaded, partially cylindrical wall 52. The partial nut is movable or flippable from a disengaged or unlocked position (shown on the right in FIGS. 4 and 5 and in FIG. 3) to an engaged or locked position (shown on the left in FIGS. 4 and 5 and in FIGS. 1 and 2). In the disengaged position, the threaded rod can be passed rapidly through the aperture 44 in the linkage bar 32 until the pressure block 24 abuts the object. In the engaged position, the threads 52 on the partial nut 48 engage with the threads on the associated threaded rod 28, thereby allowing the threaded rod to rotate with respect to the threaded member. When engaged in this manner, the threaded rod can be advanced a smaller distance by turning the rod through a suitable angle, such as a half-turn. This turning of the rod advances the pressure block 24 toward the object by the same smaller distance, thus applying a pre-load through the pressure block to the object. A nut 54, turnable with a wrench, can be attached to the back ends of the rods 28 to turn the rods. In another option, a hole 56 can be placed through the nut, and a screw driver or other tool placed through the hole to turn the rod.

In the embodiment shown, the preloading element includes a stationary support portion 58 affixed to the linkage bar. The stationary support portion includes an unthreaded aperture 62 to aid in supporting the rod. The movable partial nut 48 is pivotably attached to the stationary support portion and the linkage bar about a hinge pin that extends through both the stationary support portion and the partial nut. The movable partial nut includes a tab or gripping portion 64 to aid a user in moving the movable partial nut from the engaged position to the disengaged position or vice versa, for example, by applying leverage with the thumb.

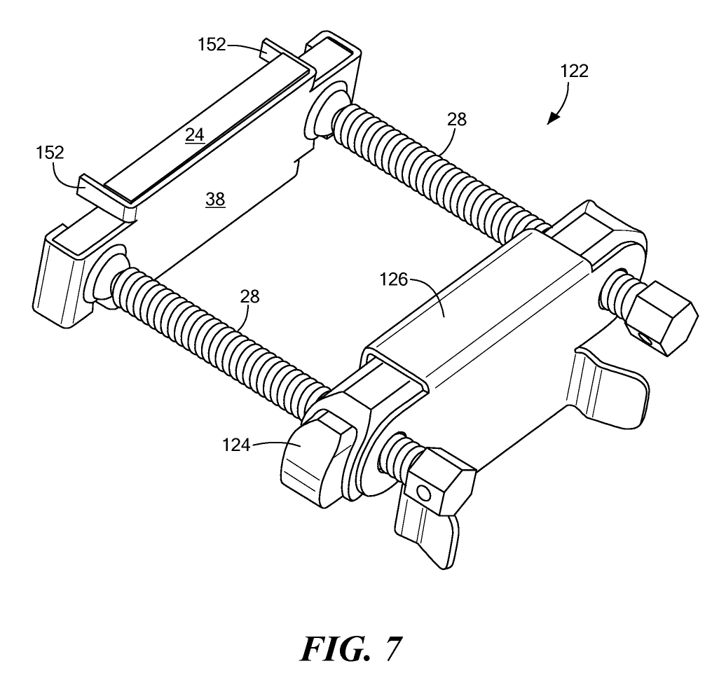

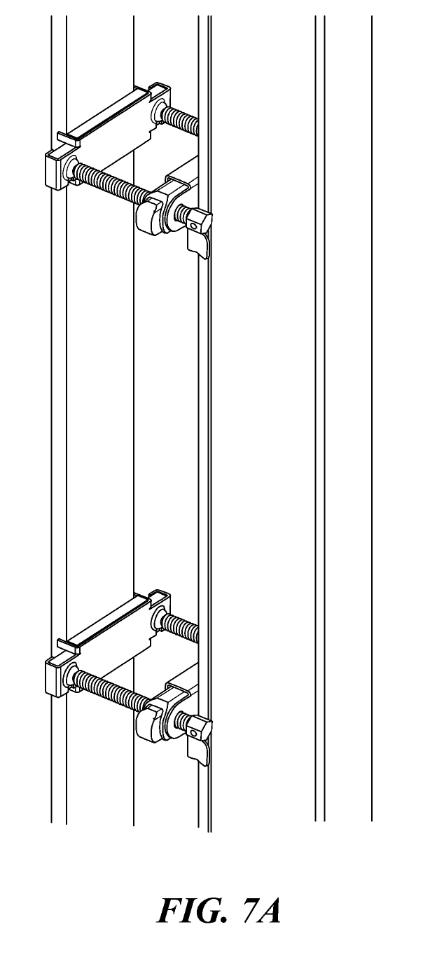

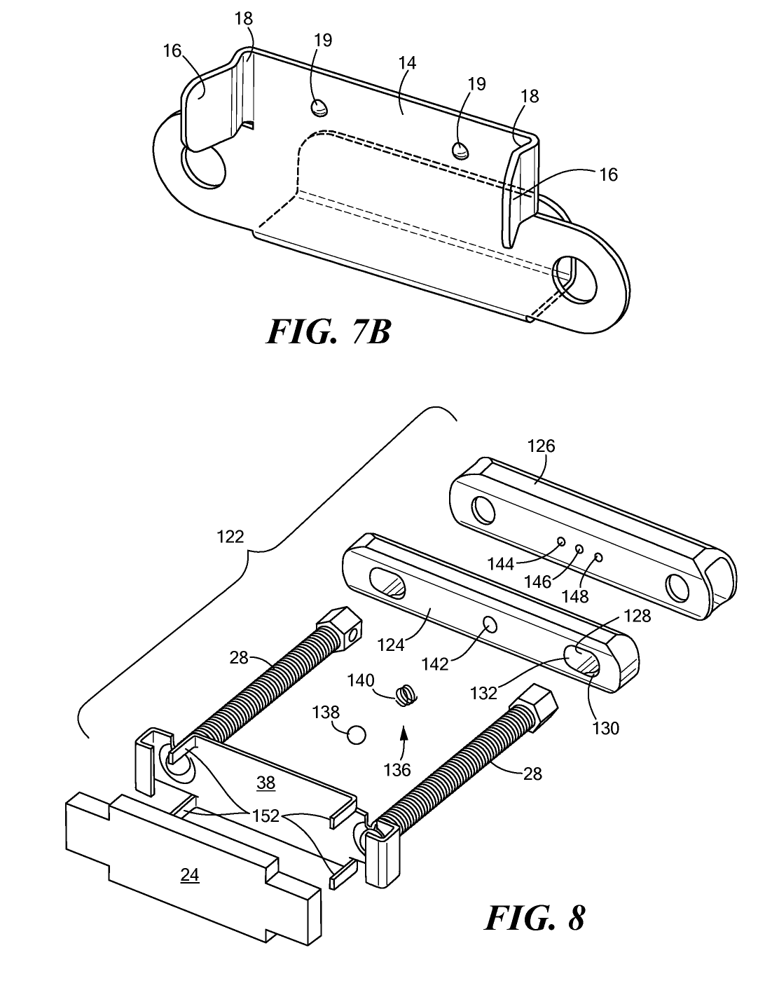

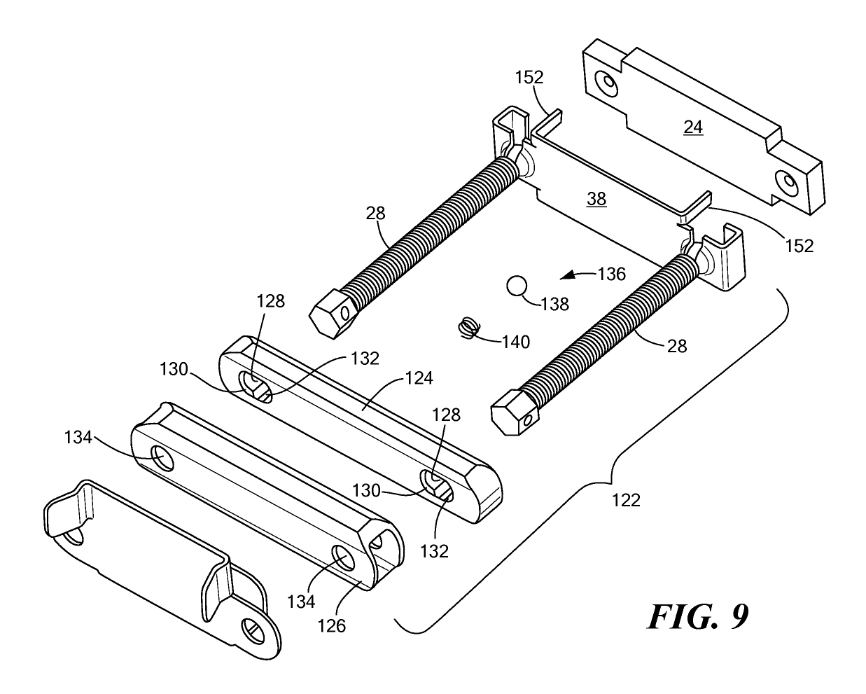

In another embodiment, referring to FIGS. 7-9, a loading mechanism 122 includes a pair of nested linkage bars 124, 126. The inner bar 124 includes a pair of widened apertures 128. One side 130 of each aperture is threaded, and the other side 132 of each aperture is not threaded. The outer bar or sheath 126 includes a pair of unthreaded apertures 134 aligned with the apertures 128 of the inner bar 124 so that the threaded rods 28 can fit through. When the inner bar 124 is slid in one direction, to the left in FIG. 9, the threaded rods 28 do not engage with the threads 130 on the inner apertures 128 and can slide readily through the apertures 128 to advance the pressure block 24 rapidly to the object. When the inner bar 124 is slid in the other direction, to the right in FIG. 9, the threaded side 130 of the apertures engage the threaded rod 28, and the threaded rod can be rotated to advance a smaller distance. In this manner, the pressure block 24 can be preloaded, as described above.

The inner bar 124 can be held in the engaged position by a suitable detent mechanism 136. In the embodiment shown, a ball 138 loaded with a spring 140 is fitted within a blind passage 142 in the inner bar 124. The ball 138 fits within one of several smaller detent openings 144, 146, 148 in the sheath 126. Three detent openings provide a symmetrical arrangement such that both the inner bar and sheath can then be installed in either orientation without regard to the orientation of the apertures 128. The inner bar 124 can be slid longitudinally within the sheath to move from one detent opening to another. The middle detent opening 146 is always an “unlocked” position, and one of the outer detent openings 144 or 148 defines an engaged position, depending on the orientation of the inner bar or the sheath. It will be appreciated that two detent openings could be used if desired.

In the embodiment of FIGS. 7-9, the plate 38 of the pressure block 24 includes one or more tabs or guides 152 on each side that extend beyond the pressure surface. (Two tabs on each side are shown.) The tabs can be used in conjunction with a pressure distribution board, such as a piece of wood, that is abutted against the object to distribute the pressure over a greater area. The tabs are spaced apart the width of the pressure distribution board to help hold the board in place.

The attachment plate can include a further retention mechanism to help the device remain in place on the load-bearing element when unloaded from the object. In the embodiment shown, one or more frictional members 19, such as rubber or other elastomeric members, are affixed to the attachment plate 14. See FIG. 7B. These members assist in frictionally gripping the surface of the load-bearing element, allowing the attachment plate to remain in place on the stanchion, which prevents the device from becoming misplaced or lost. It will be appreciated that the retention mechanism can be used with any embodiment of the device.

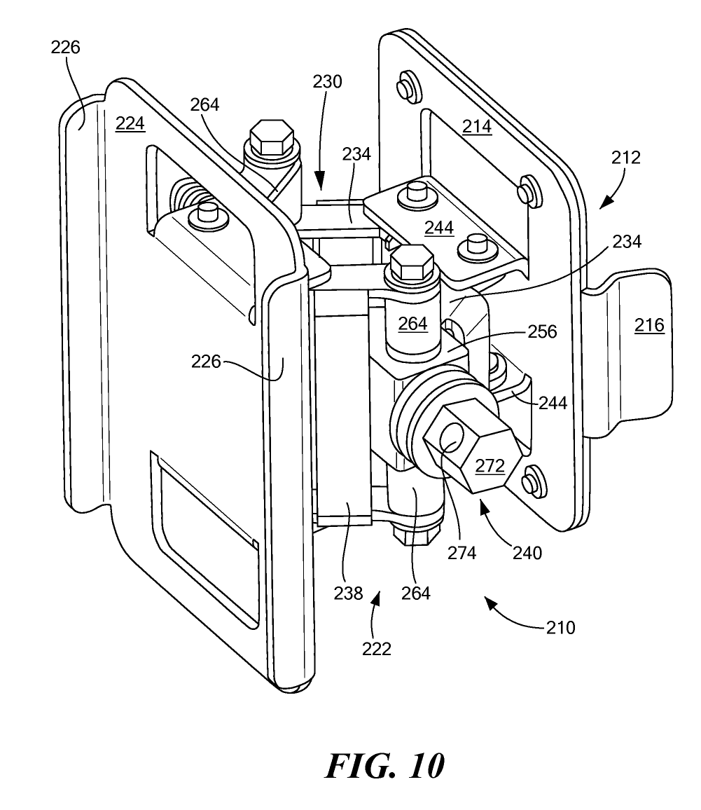

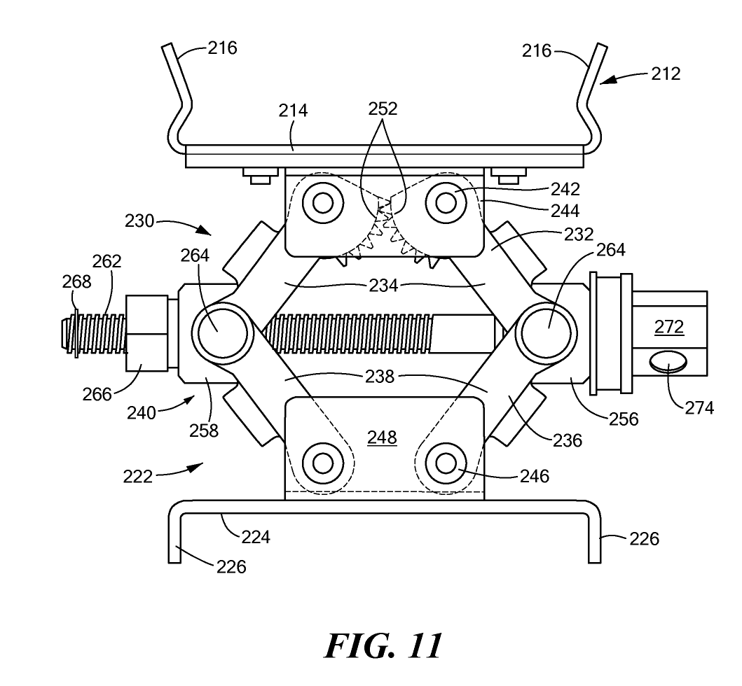

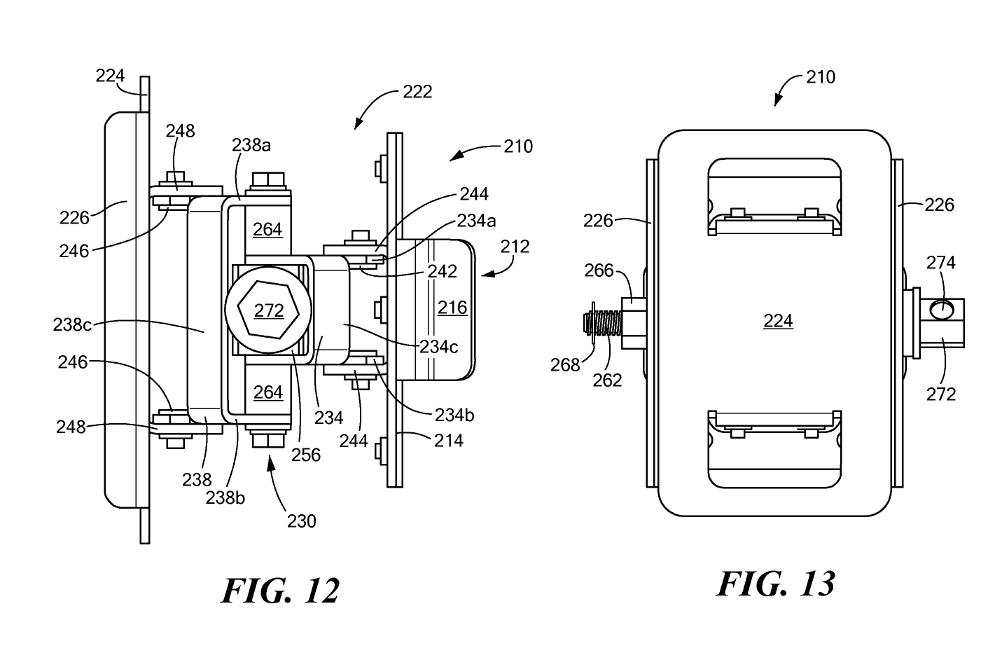

A further embodiment of a device 210 for transferring a load from an object to a load-bearing element is illustrated in FIGS. 10-13. The attachment mechanism 212 includes an attachment plate 214 having a pair of resilient tangs 216 extending from one side of the plate, as described above in conjunction with FIGS. 1-6. A loading mechanism 222 includes a pressure block 224 formed from a single sheet of metal bent along longitudinal edges to provide guides 226 for a pressure distribution board, as described above in conjunction with FIGS. 7-9.

The loading mechanism 222 includes a scissor linkage mechanism 230 affixed between the pressure block 224 and the attachment plate 214. The scissor linkage mechanism includes a first set 232 of two links 234 pivotably connected to the attachment plate 214. A second set 236 of two links 238 is pivotably connected to the pressure block 224. The first and second sets of links are pivotably connected together at an intermediate joint mechanism 240.

The links can be formed in any suitable manner. In the embodiment shown, each link of a set of links includes an upper link arm 234a, 238a and a lower link arm 234b, 238b attached with a connecting arm 234c, 238c. The upper link arm, lower link arm, and connecting arm can all be formed from a single piece of metal. The upper and lower link arms of the first set 232 of links are attached via suitable bearings 242 to sections 244 of the attachment plate that have been cut away and bent inwardly away from the load-bearing element. Similarly, the upper and lower link arms of the second set 236 of links are attached via suitable bearings 246 to sections 248 of the pressure block that have been cut away and bent inwardly away from the pressure surface. A meshing set of teeth 252 between the link ends of the first set 232 of links at the attachment plate 214 helps to keep the scissor linkage mechanism from moving except when actuated.

The intermediate joint mechanism 240 includes a pair of blocks 256, 258 each having an aperture therethrough. The aperture in the first block 256 is unthreaded, and the aperture in the second block 258 is threaded. A threaded rod or turning screw 262 extends through both apertures, engaging the threads in the aperture in the second block. As the turning screw is rotated, the blocks are either drawn toward each other or moved apart.

Rotatable bearings 264 are mounted on blocks. The first and second sets of links are pivotably attached to the rotatable bearings. When the turning screw is rotated to draw the blocks together, the links are rotated outwardly in opposite directions, extending the scissor linkage mechanism. In this manner, the pressure block is moved into contact with the object to be loaded. When the turning screw is rotated to move the blocks apart, the links are rotated inwardly in opposite directions, retracting the scissor linkage mechanism. In this manner, the pressure block is moved out of contact with the object.

When the scissor linkage mechanism 230 has been extended to apply a sufficient preload on the object, a nut 266 on the end of the turning screw is tightened to prevent the linkage mechanism from loosening, for example, due to vibrations. A clip 268 on the end of the turning screw 262 can be provided to prevent the nut from falling off when the device is not in use. The turning screw can include a nut 272 on the other end that can be turned with a wrench. In another option, a hole 274 can be placed through the nut, and a screw driver or other tool placed through the hole to turn the turning screw. A pressure bearing can be provided between the nut and the first block.

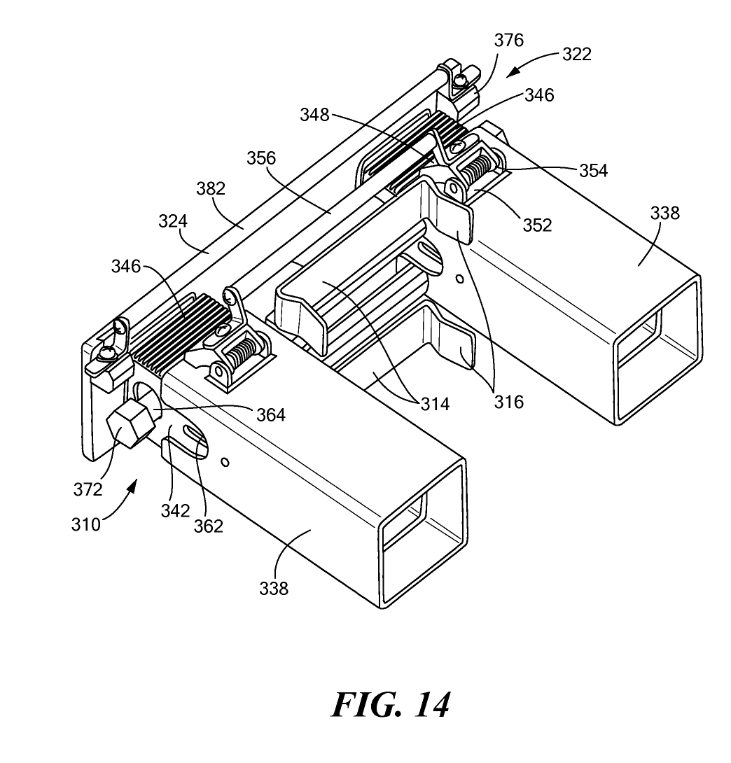

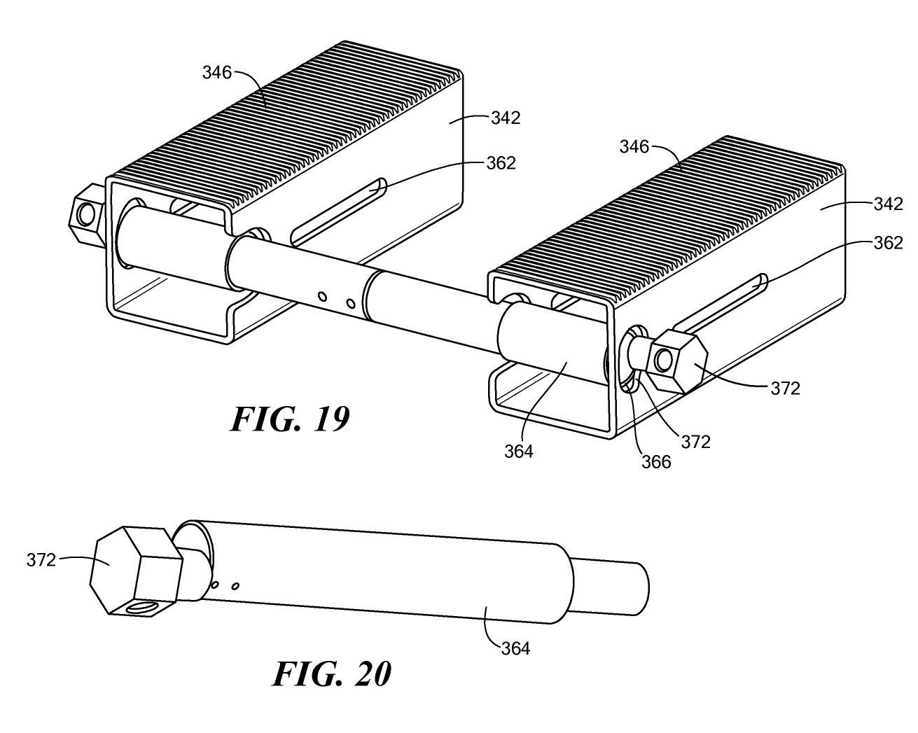

A further embodiment of a device 310 for transferring a load from an object to a load-bearing element is illustrated in FIGS. 14-21. The attachment mechanism 312 includes two attachment plates 314 each having a pair of resilient tangs 316 extending from one side of the plate. The loading mechanism 322 includes a pressure block 324 providing a pressure surface 330. Guides or tabs for a pressure distribution board, as described above, are not shown, but can be provided if desired.

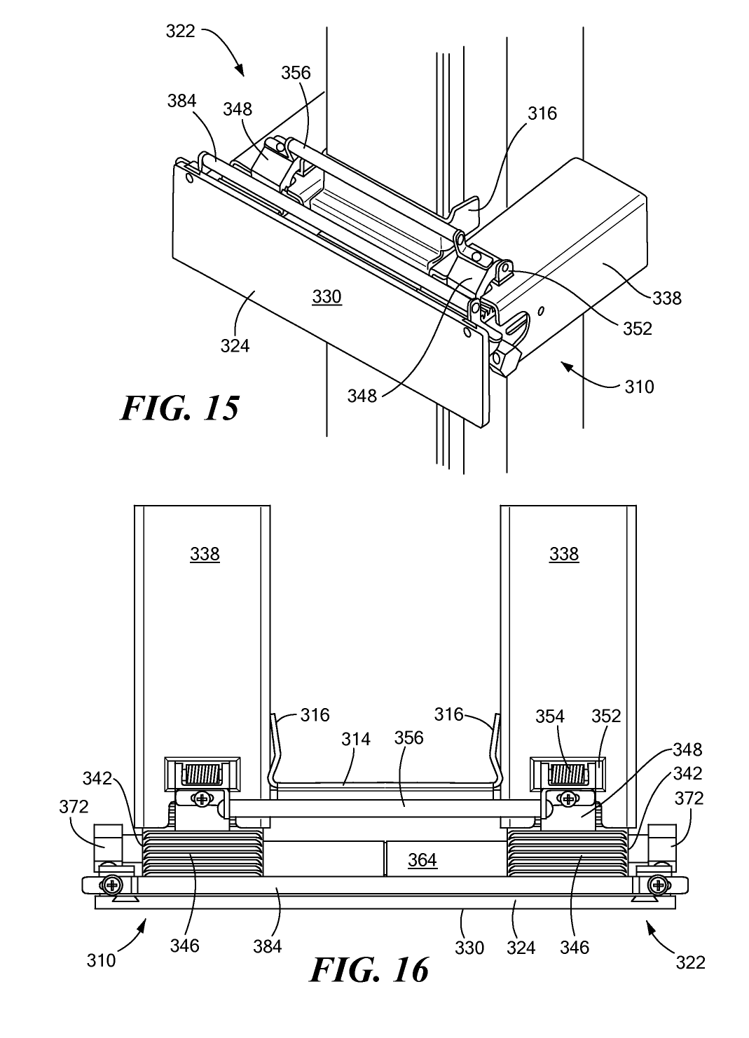

The loading mechanism includes a ratchet and pawl mechanism 332 and a cam mechanism 336 affixed between the pressure block 324 and the attachment plate 314. Two sets of three telescoping tubes 338, 342, 344 are provided, one set extending on each side of the load-bearing element (see FIG. 15). The outer tubes 338 are affixed to the attachment plates 314, in any suitable manner, such as by upper and lower connecting bars attached to flanges on each of the attachment plates. The pressure block is attached to the inner tubes 334. The ratchet and pawl mechanism provides for gross movement of the pressure block to the object to be loaded by relative movement of the middle tube 342 within the outer tube 338. The cam mechanism provides finer movement of the pressure block via the inner tube 344 to apply a preload to the object.

The ratchet and pawl mechanism 332 connects the outer tube 338 and the middle tube 342. The ratchet and pawl mechanism includes a ratchet plate 346 having evenly spaced, angled teeth formed on a top surface of each middle tube. A pawl or lock block 348 is hingedly attached to a bracket 352 mounted on the top of the outer tube 338. The pawl includes a tooth that engages with one of the teeth on the ratchet plate 346 to prevent rearward motion of the ratchet plate away from the object. The pawl is hingedly attached to the outer tube via a biasing mechanism 354, such as a torsion spring, to bias the pawl tooth into engagement with the ratchet plate. The pawl includes a handle 356, which may be a bar connecting the pawls on both outer tubes, that can be retracted by a user to disengage the pawl, allowing the ratchet plate to be moved rearwardly away from the object.

The middle tube 342 can also be retained within the outer tube in any suitable manner. For example, a pin 358 within the outer tube fits within a longitudinal slot 362 in the middle tube, allowing linear translation of the middle tube within the outer tube for the length of the slot.

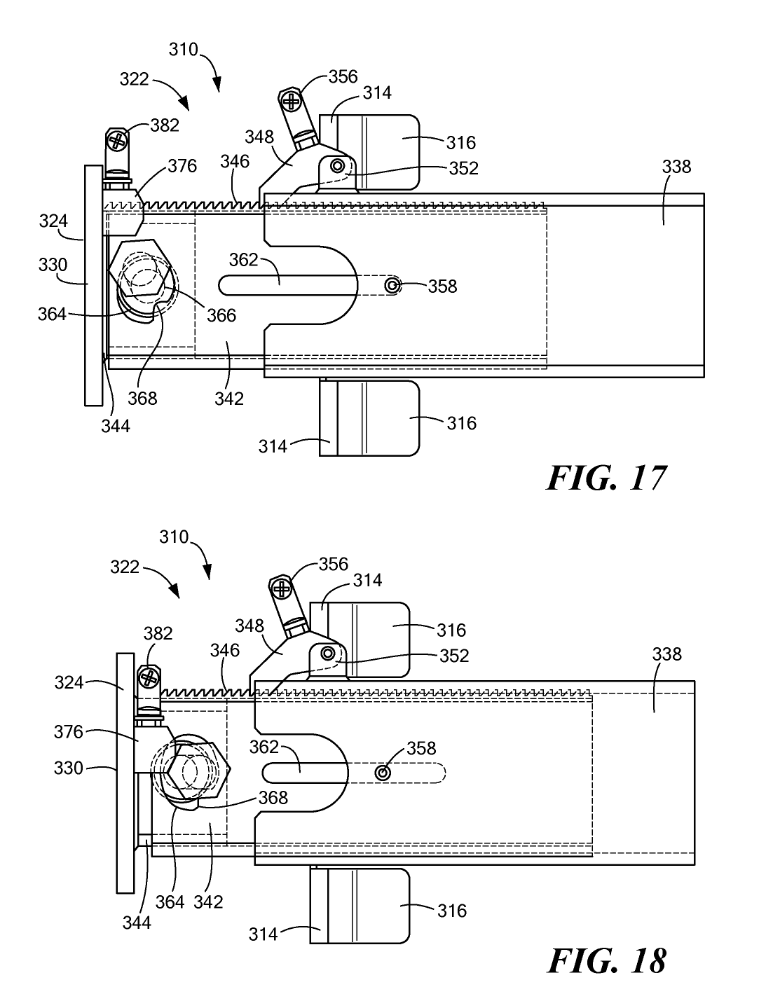

The ratchet and pawl mechanism 332 allows the device to be moved into close contact with the object. Once in this position, the cam mechanism 336 of the loading mechanism allows the device to apply a preload to the object. The cam mechanism includes a cam rod 364 that extends through openings 366 in the middle tube 342 and is coupled to the inner tube 344, for example, via apertures in the inner tube generally aligned with the openings in the middle tube, such that linear movement of the cam rod moves the inner tube and the pressure block affixed to the inner tube. The outermost openings in the middle tube have a cam surface 368, illustrated in FIG. 17. The cam rod includes a handle element 372 eccentrically affixed to one or both ends of the cam rod. The handle element rides along the cam surfaces, such that rotation of the handle element causes motion of the cam rod 364 with a component in a direction toward or away from the object. FIG. 18 illustrates the device in a preloaded position, with the inner tube 344 extended from the middle tube 342. FIG. 17 illustrates the device in an unloaded position, with the inner tube 344 retracted within the middle tube 342. In the embodiment shown, the handle element includes a nut, which can be turned by a wrench, attached to a shaft that is eccentrically fixed to the cam rod 364.

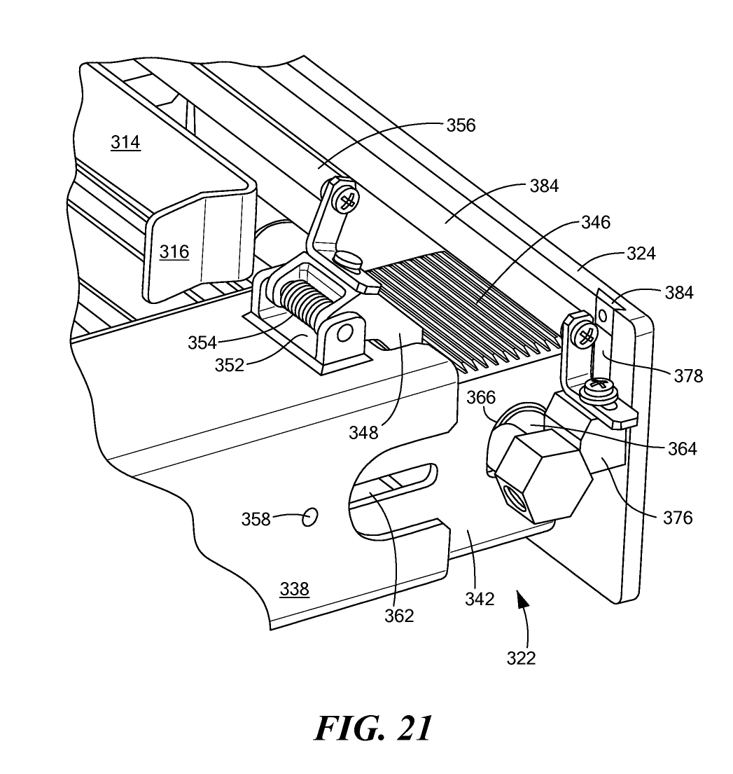

A cam block 376 is provided on one or both sides of the pressure block mounted for linear vertical motion in a track 378, such as a dove tail groove in the pressure block. The cam blocks each have a cam block surface that engages with a corresponding surface on the handle element 372 to lock the handle element from further rotation out of the preloaded position. The cam blocks are biased, for example, via gravity, into the locked position, and can be lifted into an unlocked position, for example, via a handle 382 extending from both cam blocks across the top of the pressure block. A stop 384 in the top of each dove tail groove (FIG. 21) prevents the cam block from being removed from the device.

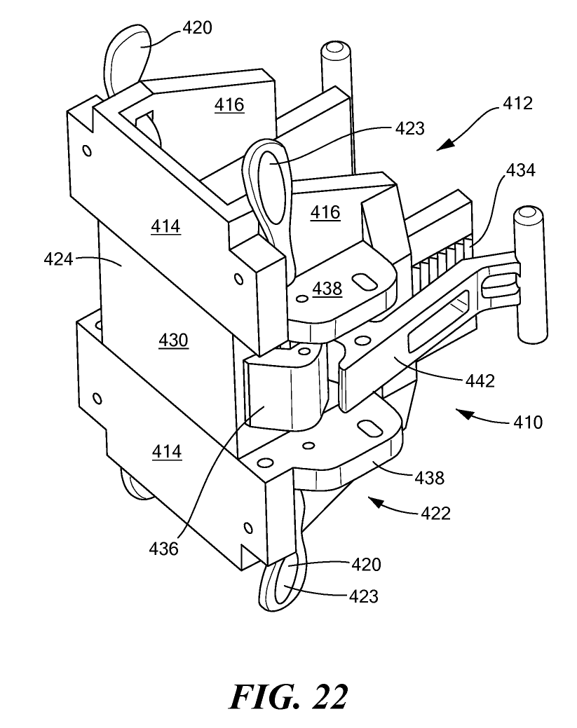

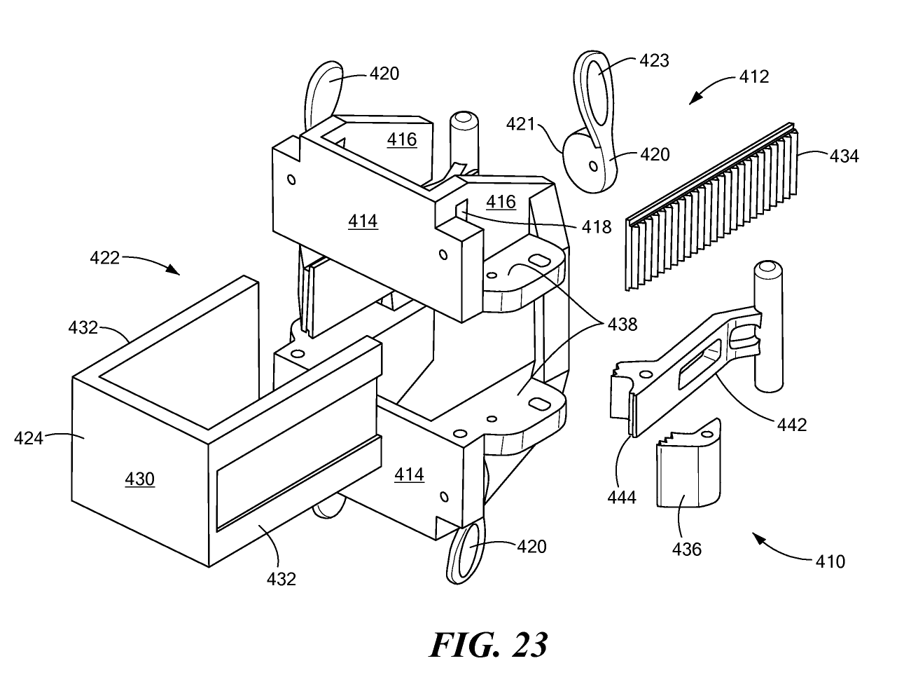

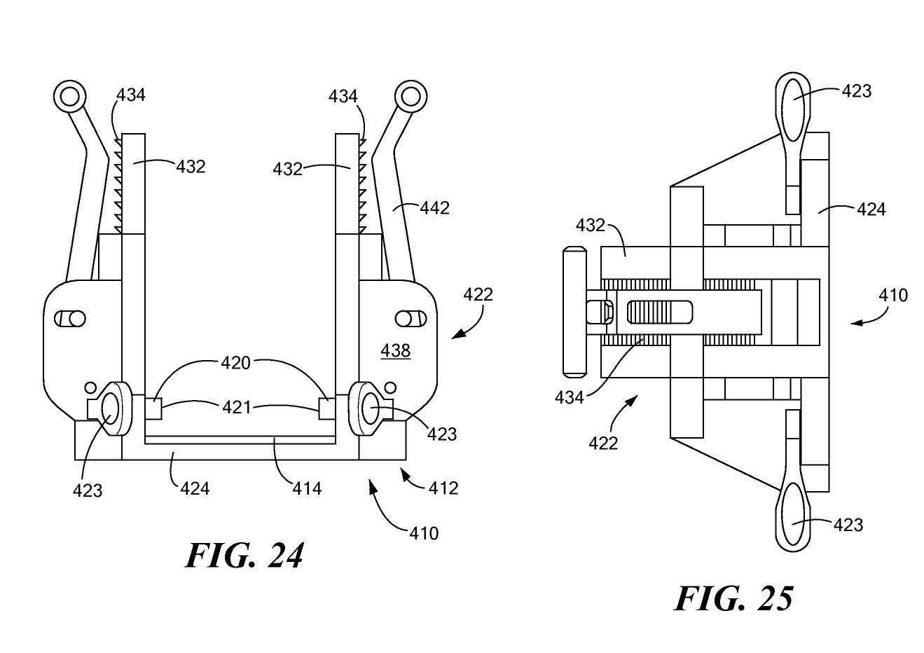

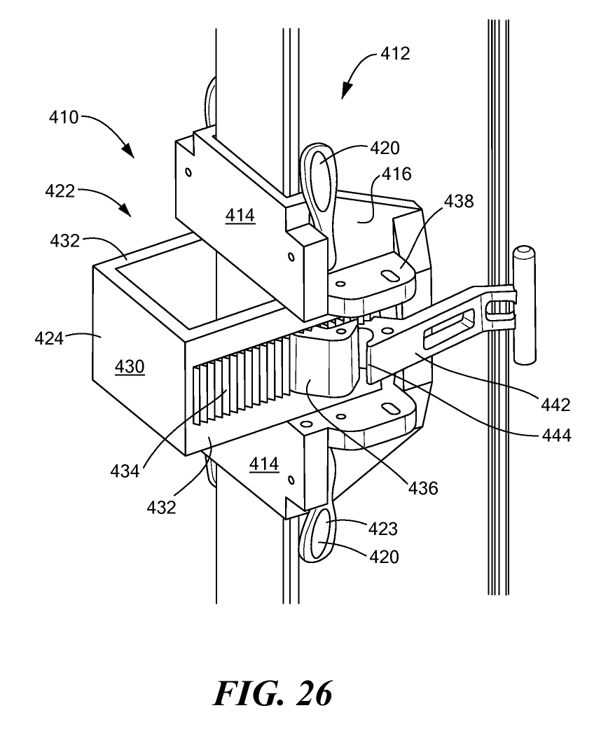

A further embodiment of a device 410 for transferring a load from an object to a load-bearing element is illustrated in FIGS. 22-26 The attachment mechanism 412 includes an attachment plate 414 that extends across the front of a load-bearing element. In the embodiment illustrated, the attachment plate is formed in two parts. A pair of side plates 416 extends from the attachment plate, or from the parts of the attachment plate, along the sides of the load-bearing element. One or more slots 418 are formed through the side plates. A gripping element 420 is hingedly mounted to the attachment plate and includes a cam surface 421 that extends through the slot 418 for gripping contact with the load-bearing element. A thumb tab 423 extends outside of the slot for actuation by a user. When the thumb tab is rotated into one position (up in FIGS. 22-24), the cam surface 421 abuts and frictionally grips the load-bearing element. When the thumb tab is rotated into another position (outwardly in FIG. 25), the cam surface 421 cannot reach the load-bearing element, allowing the device to be installed or removed.

A loading mechanism 422 includes a pressure block 424 providing a pressure surface 430 facing the object. Guides or tabs for a pressure distribution board, as described above, are not shown, but can be provided if desired. The pressure block includes side extensions 432 that fit outwardly of the side plates 416 of the attachment plate 414. A ratchet plate 434 is fitted within recesses formed in each side extension 432. A pawl 436 is hingedly mounted to the attachment plate, for example, on upper and lower ears 438 extending from the side plates 416. The pawl is biased into engagement with the teeth of the ratchet plate, for example, with a torsion spring, to prevent rearward movement of the ratchet plate. A loading handle 442 is also hingedly mounted to the ear plates and biased, for example, with a torsion spring, into a locked position. The loading handle includes a tooth or set of teeth that engages the teeth of the ratchet plate. When the handle is pushed inwardly against the bias, the teeth on the handle engage the teeth on the ratchet plate and push the ratchet plate forward toward the object to be preloaded. A nose 444 on the handle prevents the pawl 436 from moving out of engagement with the ratchet plate. When the handle is moved outwardly, the nose pushes on the pawl, rotating the pawl out of engagement with the ratchet plate and allowing the ratchet plate to be pulled rearwardly, out of contact with the object.

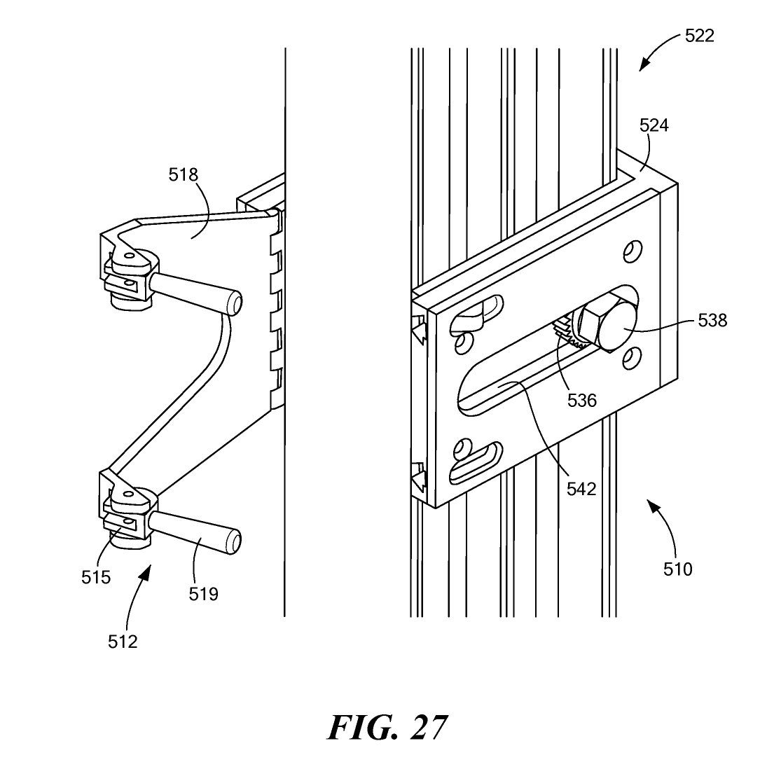

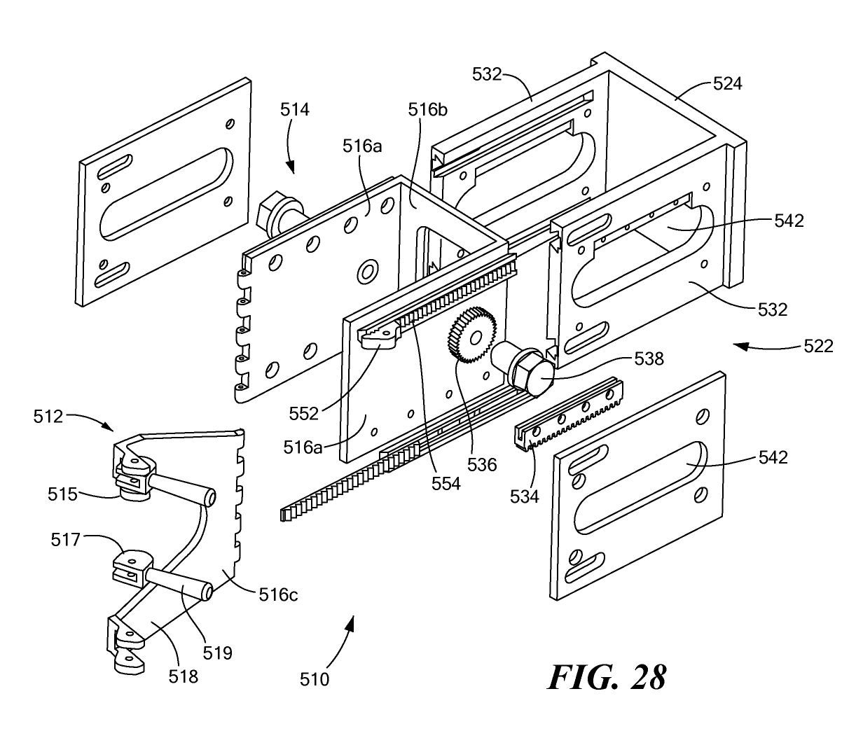

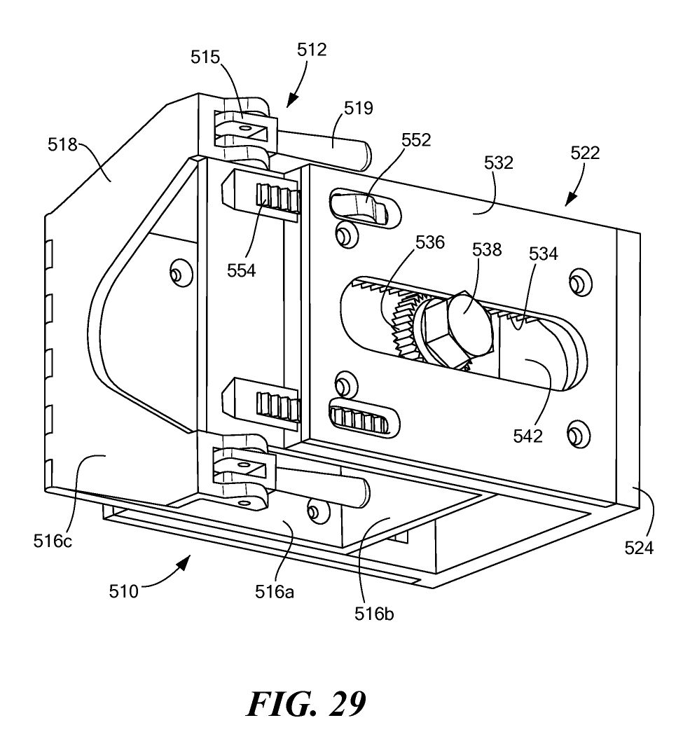

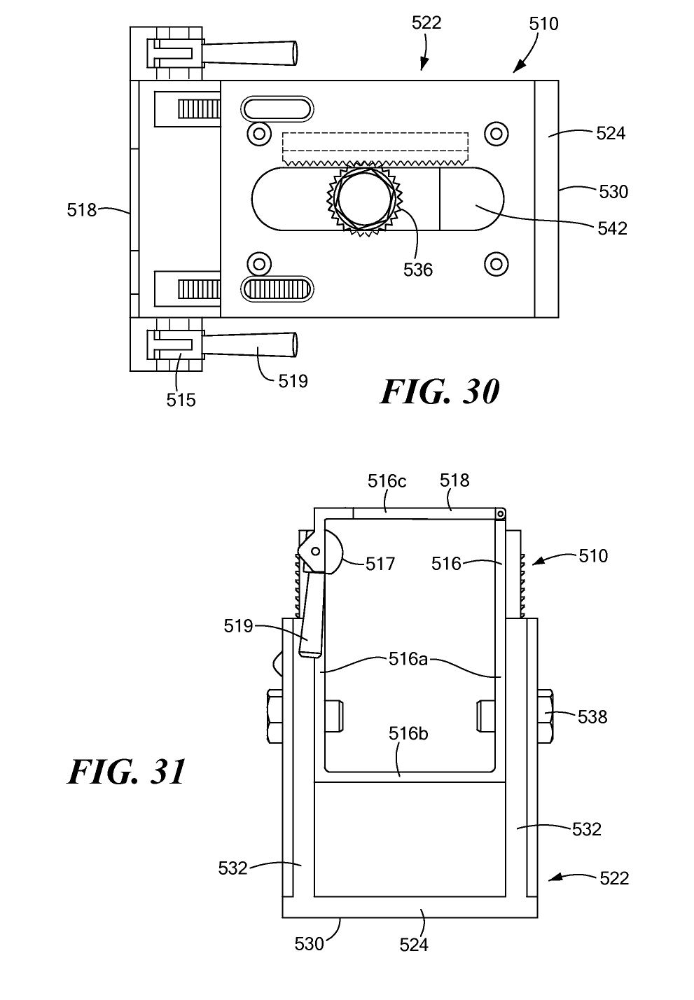

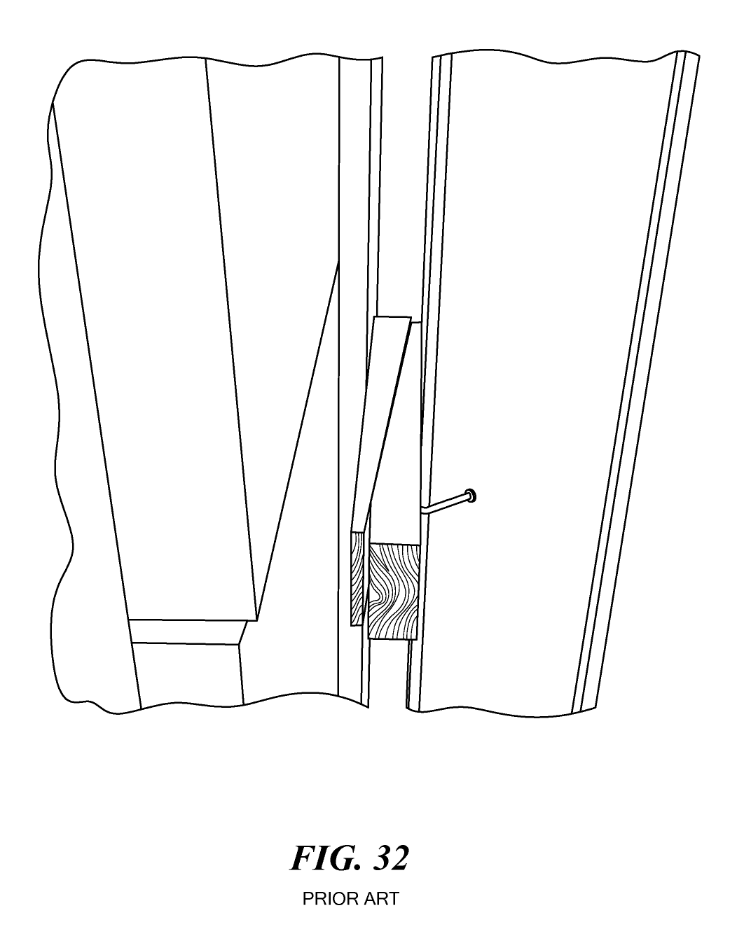

A further embodiment of a device 510 for transferring a load from an object to a load-bearing element is illustrated in FIGS. 27-31. The attachment mechanism 512 includes an assembly 514 having elements 516a, 516b, 516c that wrap around the circumference of the load-bearing element. One element 516c of the wrap assembly is a hinged plate or door 518 that closes about the rear of the load-bearing element. One or more gripping elements 515 are hingedly mounted to the hinged door 518 and include a cam surface 517 for gripping contact with sides of the load-bearing element. A handle 519 on the gripping element can be used to rotate the cam surface into a gripping position in which the cam surface abuts and frictionally grips the load-bearing element. When the handle is rotated into another position, the cam surface cannot reach the load-bearing element, allowing the device to be installed or removed.

The loading mechanism 522 includes a pressure block 524 providing a pressure surface 530 facing the object. Guides or tabs for a pressure distribution board, as described above, are not shown, but can be provided if desired. The pressure block includes side extensions 532 that fit outwardly of the elements of the wrap assembly of the attachment mechanism.

The loading mechanism includes a rack and pinion mechanism including a rack 534 affixed to one or both side extensions 532 of the pressure block. One or more pinion gears 536 are mounted to the side elements 516a for engagement with the rack. Rotation of the pinion gear, for example, via the handle element or nut 538 through a slot 542, advances or retracts the pressure block into or out of engagement with the object. A pawl 552 engageable with a rack 554 holds the pressure block in the preloaded position. The pawl can be disengaged from the rack, for example, by pivoting against the bias of a torsion spring, to retract the pressure block.

The device can be manufactured out of any suitable material. A metal such as stainless steel is typically acceptable and may be desirable in environments that are subject to corrosion or contamination, such as on a ship. Thus, the device is uncompromised by seawater or galvanic corrosion.

The device can be used in place of wooden wedges that are typically used in preloading cargo within a ship's hold. The device can be manufactured with the desired strength-to-weight ratio for the design loads in Navy ships. The device is uncompromised by continual vibrations, such as are present in a ship. The device can maintain the load during severe shock events, but also fail prior to the stanchion, which is a more costly component.

The device is simple to use and requires only basic tools that are typically at hand, such as a wrench or screw driver. It can be operated from attachment to the load-bearing element to preloading the cargo in less than 30 seconds. The device is reusable. The device can remain attached to the load-bearing element so that it does not get lost, such as before loading and after unloading or if a portion of the cargo must be accessed for some reason.

While the device has been described in conjunction with a ship and the loading of cargo within the hull of a ship using vertical stanchions, the device can be employed in other applications, such as with other modes of transportation, for example, with trucks, railroad cars, or airplanes.

It will be appreciated that various aspects of each embodiment may be used with other embodiments. The invention is not to be limited by what has been particularly shown and described, except as indicated by the appended claims.

What is claimed is:

1. A device comprising:
an attachment mechanism for attaching to a load-bearing element, the load-bearing element disposed in compression between surfaces; and
a loading mechanism for applying a preload to an object and for transmitting a force from the object to the load-bearing element, comprising a pressure block and a mechanism interconnecting the pressure block and the attachment mechanism.

2. The device of claim 1, wherein the attachment mechanism comprises an attachment plate, and a pair of opposed, resilient tangs extending from the attachment plate and biased inwardly toward each other and spaced to fit around edges of the load-bearing element.

3. The device of claim 1, wherein the attachment mechanism comprises an attachment plate and at least one elastomeric frictional member on the attachment plate to extend in frictional engagement with the load-bearing element.

4. The device of claim 1, wherein the attachment mechanism comprises an attachment plate and a pair of opposed gripping elements, the gripping elements including a cam surface disposed to contact the load-bearing element in a gripping position and to be out of contact with the load-bearing element in a released position, the gripping elements hingedly mounted to the attachment to rotate between the gripping position and the released position.

5. The device of claim 1, wherein the pressure block includes a pressure surface disposed toward the object.

6. The device of claim 1, wherein the interconnecting mechanism comprises:
a pair of externally threaded rods arranged in parallel;
a pair of nested linkage bars comprising an inner bar and a sheath, the inner bar including a pair of apertures, each aperture receiving one rod of the pair of rods for translation through the aperture, each aperture including a partially threaded portion for engaging the threaded rod.

7. The device of claim 1, wherein the loading mechanism comprises:
a pair of externally threaded rods arranged in parallel;
a linkage bar extending between the pair of rods, the linkage bar including a pair of apertures, each aperture receiving one rod of the pair of rods for translation through the aperture,
a pair of preloading elements, each preloading element rotatable into threaded engagement with one of the threaded rods.

8. The device of claim 1, wherein the interconnecting mechanism comprises:
a pair of externally threaded rods, a ball formed on an end of each rod; and
a pair of recesses is formed in the pressure block, each ball captured within an associated recess in the pressure block, whereby the pressure block is adjustable.

9. The device of claim 1, wherein the interconnecting mechanism comprises a scissor mechanism comprising:
a first set of links rotatably connected to the attachment mechanism,
a second set of links rotatably connected to the pressure block and pivotably connected to the first set of links at a pivoting joint mechanism, and
an actuator connected to the first and second sets of links at the pivoting joint mechanism to extend and retract the links by rotation of the pivoting joint mechanism.

10. The device of claim 1, wherein the interconnecting mechanism comprises:
a ratchet and pawl mechanism disposed to provide gross movement of the pressure block; and
a cam mechanism disposed to provide finer movement of the pressure block.

11. The device of claim 1, wherein the interconnecting mechanism comprises a ratchet and pawl mechanism comprising:
a ratchet plate extending along a side of the attachment plate and attached to the pressure block;
a pawl biased into engagement with teeth on the ratchet plate;
a loading handle operable to advance and retract the ratchet plate.

12. The device of claim 1, wherein the interconnecting mechanism comprises a rack and pinion mechanism comprising:
a rack attached to the pressure block;
a pinion gear attached to the attachment mechanism and engageable with the rack to advance and retract the rack.

13. The device of claim 1, wherein the pressure block includes opposed guides extending outwardly toward the object to receive a pressure distribution board.
